(19) United States
(12) Patent Application Publication
(10) Pub. No.: US 2026/0061852 A1
(43) Pub. Date: Mar. 5, 2026

(54) ELECTRIFIED VEHICLE

(71) Applicant: TOYOTA JIDOSHA KABUSHIKI KAISHA, Toyota-shi (JP)

(72) Inventors: Takahiro KONDO, Toyota-shi (JP); Shinji HATTORI, Toyota-shi (JP); Shoichi FUKUCHI, Okazaki-shi (JP)

(73) Assignee: TOYOTA JIDOSHA KABUSHIKI KAISHA, Toyota-shi (JP)

(21) Appl. No.: 19/169,337

(22) Filed: Apr. 3, 2025

(30) Foreign Application Priority Data
Sep. 5, 2024 (JP) 2024-153413

(51) Int. Cl. B60L 15/20; B60L 50/51

(52) U.S. Cl. CPC B60L 15/20; B60L 50/51; B60L 2240/12; B60L 2240/14; B60L 2240/423

(57) ABSTRACT

When target torques of the first electric motor and the second electric motor exceed a play region in which a play occurs with respect to current execution torques, intermediate torques near the play region are set as the target torques, and the execution torques of the first electric motor and the second electric motor are adjusted to reach the target torques at the same time.

### CROSS-REFERENCE TO RELATED APPLICATION

This application claims priority to Japanese Patent Application No. 2024-153413 filed on Sep. 5, 2024. The disclosure of the above-identified application, including the specification, drawings, and claims, is incorporated by reference herein in its entirety.

### BACKGROUND

### 1. Technical Field

The present disclosure relates to an electrified vehicle, and more particularly, to an electrified vehicle including a first electric motor that inputs and outputs a drive force to and from a first axle and a second electric motor that inputs and outputs a drive force to and from a second axle.

### 2. Description of Related Art

In the related art, as this kind of electrified vehicle, a technique has been proposed in which, when a drive force transmission mechanism of one of a front motor and a rear motor passes through a backlash section (play region), a torque of the other motor is corrected (for example, see Japanese Unexamined Patent Application Publication No. 2024-098879 (JP 2024-098879 A)). In the electrified vehicle, the torque of the other motor is corrected such that the acceleration or deceleration desired by a driver is realized.

### SUMMARY

In an electrified vehicle including a first electric motor for front wheels and a second electric motor for rear wheels, when a target torque crosses a play region of each of the drive force transmission mechanisms with respect to a current torque (execution torque), in a case where a timing at which the target torque of the first electric motor crosses the play region and a timing at which the target torque of the second electric motor crosses the play region are different even slightly, an acceleration of the vehicle may deviate from a target acceleration, or an unexpected shock may occur due to a change in collision energy at the time of play joining. This causes a sense of discomfort to a driver or a passenger.

An electrified vehicle of the present disclosure includes a first electric motor that inputs and outputs a drive force to and from a first axle and a second electric motor that inputs and outputs a drive force to and from a second axle. A main object of the electrified vehicle is to reduce a sense of discomfort that occurs to a driver or a passenger due to a deviation in timing when target torques of the first electric motor and the second electric motor exceed a play region in which a play occurs.

An electrified vehicle according to the present disclosure adopted the following aspects in order to achieve the above-described main object.

An electrified vehicle according to the present disclosure includes: a first electric motor configured to input and output a drive force to and from a first axle; a second electric motor configured to input and output a drive force to and from a second axle different from the first axle; and a control device configured to control the first electric motor and the second electric motor, in which when target torques of the first electric motor and the second electric motor exceed a play region in which a play occurs with respect to current execution torques, the control device configured to set intermediate torques near the play region as the target torques, and adjust execution torques of the first electric motor and the second electric motor to reach the target torques at the same time.

The electrified vehicle of the present disclosure includes a first electric motor that inputs and outputs a drive force to and from a first axle, a second electric motor that inputs and outputs a drive force to and from a second axle different from the first axle, and a control device that controls the first electric motor and the second electric motor. When target torques of the first electric motor and the second electric motor exceed a play region in which a play occurs with respect to current execution torques, intermediate torques near the play region are set as the target torques. The execution torques of the first electric motor and the second electric motor are adjusted to reach the target torques (intermediate torques) at the same time. As a result, the execution torques of the first electric motor and the second electric motor can cross the play region substantially at the same time. As a result, it is possible to reduce a sense of discomfort that occurs to a driver or a passenger due to a deviation in timing when the execution torques of the first electric motor and the second electric motor exceed the play region.

In the electrified vehicle according to the present disclosure, the intermediate torques may be torques that slightly exceed the play region (torques that exceed the play region by a predetermined torque) with respect to the current execution torques of the first electric motor and the second electric motor. In this way, the execution torques of the first electric motor and the second electric motor can cross the play region substantially at the same time.

In the electrified vehicle according to the present disclosure, the control device may calculate rate values such that the execution torques of the first electric motor and the second electric motor become the intermediate torques at the same time, and may set the execution torques by a rate limit process using the rate values.

In this way, the execution torques can easily reach the intermediate torques at the same time.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a configuration diagram showing a schematic configuration of an electrified vehicle 20 as an embodiment of the present disclosure;

FIG. 2 is a flowchart showing an example of an execution torque setting process executed by an electronic control unit 60;

FIG. 3 is a flowchart showing an example of a torque rate setting process executed by the electronic control unit 60; and

FIG. 4 is an explanatory diagram showing an example in which target torques T1* and T2* of a first motor 22 and a second motor 32 cross a play region with respect to execution torques T1 and T2.

### DETAILED DESCRIPTION OF EMBODIMENTS

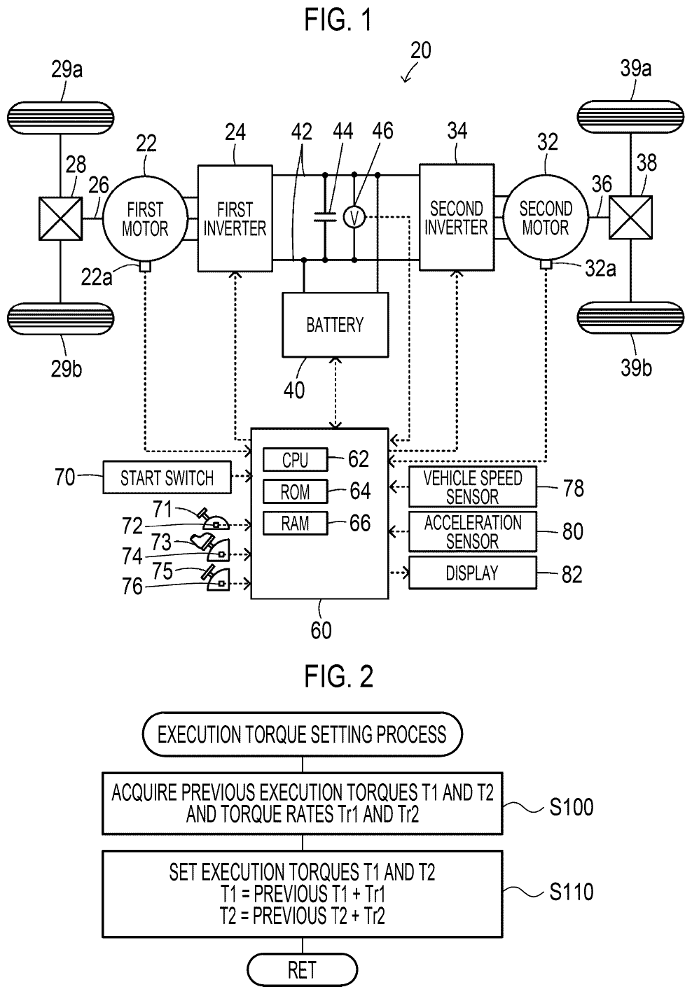

Next, an embodiment for implementing the present disclosure will be described. FIG. 1 is a configuration diagram showing a schematic configuration of an electrified vehicle 20 as an embodiment of the present disclosure. The electrified vehicle 20 of the embodiment includes a first motor 22, a first inverter 24, a second motor 32, a second inverter 34, a battery 40, and an electronic control unit 60.

The first motor 22 and the second motor are configured as, for example, a synchronous generator motor. A rotor (not shown) of the first motor 22 is connected to a drive shaft 26 connected to front wheels 29a and 29b via a differential gear 28. A rotor (not shown) of the second motor 32 is connected to a drive shaft 36 connected to rear wheels 39a and 39b via a differential gear 38. Rotation position detection sensors 22a and 32a that detect a rotation position of a rotor are attached to the first motor 22 and the second motor 32.

The first inverter 24 and the second inverter 34 are configured as a well-known inverter circuit having six transistors and six diodes. The first inverter 24 and the second inverter 34 are connected to a power line 42 connected to the battery 40. The first inverter 24 converts the direct current electric power from the battery 40 into three-phase alternating current by PWM control, and applies the three-phase alternating current to the first motor 22 to drive the first motor 22. The second inverter 34 converts the direct current electric power from the battery 40 into three-phase alternating current by the PWM control, and applies the three-phase alternating current to the second motor 32 to drive the second motor 32 in the same manner as the first inverter 24.

The battery 40 is configured as, for example, a lithium ion battery and is connected to the power line 42. A voltage sensor (not shown) that detects a battery voltage Vb is attached to both terminals of the battery 40. A current sensor (not shown) that detects a battery current Ib is attached to the terminals of the battery 40. A smoothing capacitor 44 or a voltage sensor 46 that detects a voltage VH of the smoothing capacitor 44 is attached to the power line 42.

The electronic control unit 60 is configured as a microcomputer centered on a CPU 62. The electronic control unit 60 includes a ROM 64, a RAM 66, a flash memory (not shown), an input port (not shown), an output port (not shown), and the like, in addition to the CPU 62.

The electronic control unit 60 inputs the rotation positions θ1 and θ2 of the first motor 22 and the second motor 32 detected by the rotation position detection sensors 22a and 32a, the voltage VH detected by the voltage sensor 46, and the like via the input port. The electronic control unit 60 also inputs a start signal ST, a shift position SP, an accelerator operation amount Acc, and a brake pedal position BP from a start switch 70. The shift position SP is detected by a shift lever position sensor 72 attached to a shift lever 71. The accelerator operation amount Acc is detected by an accelerator pedal position sensor 74 attached to an accelerator pedal 73. The brake pedal position BP is detected by a brake pedal position sensor 76 attached to a brake pedal 75. The electronic control unit 60 also inputs a vehicle speed V detected by a vehicle speed sensor 78 and an acceleration α detected by an acceleration sensor 80.

The electronic control unit 60 outputs a switching control signal to the first inverter 24 and the second inverter 34, a display control signal to a display 82, or the like, via the output port. The electronic control unit 60 calculates rotation speeds Nm1, Nm2 of the first motor 22 and the second motor 32 based on the rotation positions θ1 and θ2 of the rotors of the first motor 22 and the second motor 32. The electronic control unit 60 calculates an accumulated charge ratio SOC of the battery 40 based on the integrated value of the battery current Ib.

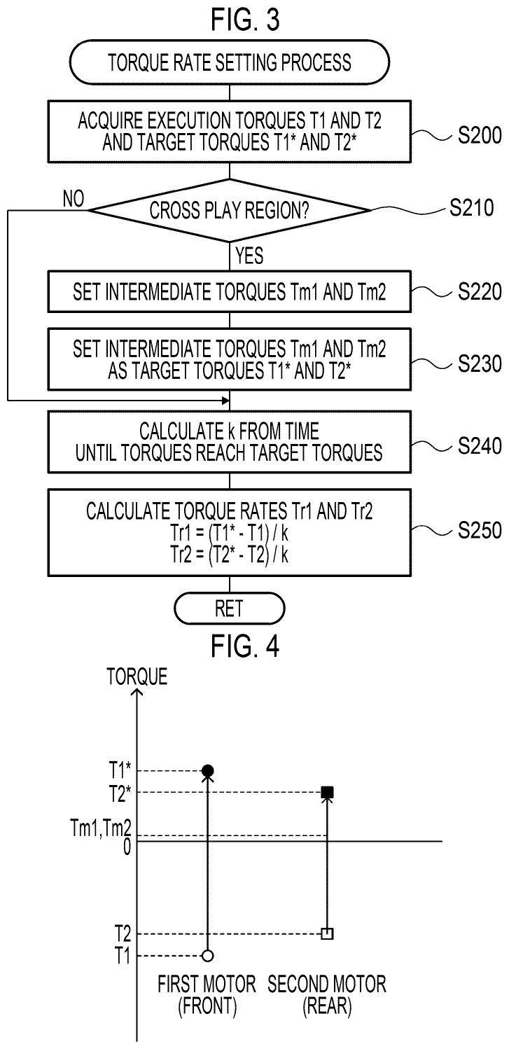

Next, the operation of the electrified vehicle 20 according to the embodiment will be described. In particular, an operation when the target torques T1* and T2* of the first motor 22 and the second motor 32 cross a play region in which a play occurs in a drive force transmission system (differential gears 28 and 38, and the like) with respect to the current execution torques T1 and T2 will be described. FIG. 2 is a flowchart showing an example of an execution torque setting process executed by the electronic control unit 60, and FIG. 3 is a flowchart showing an example of a torque rate setting process executed by the electronic control unit 60. Hereinafter, the present disclosure will be described in order. In the electrified vehicle 20 of the embodiment, a vehicle demand torque Tdrv* is set at a predetermined timing according to the accelerator operation amount Acc and the vehicle speed V. A front wheel demand torque Tf* and a rear wheel demand torque Tr* are obtained by using the front-rear distribution ratio according to the traveling state for the vehicle demand torque Tdrv*. The target torques T1* and T2* of the first motor 22 and the second motor 32 are set by multiplying the front wheel demand torque Tf* and the rear wheel demand torque Tr* by the gear ratio of the drive force transmission system.

When the execution torque setting process in FIG. 2 is executed, the electronic control unit 60 acquires the execution torques T1 and T2 and the torque rates Tr1 and Tr2 set when the process was executed last time (S100). The torque rates Tr1 and Tr2 are acquired by inputting the torque rates set by the torque rate setting process in FIG. 3 described below. Then, torques obtained by adding the torque rates Tr1 and Tr2 to the previous execution torques T1 and T2, respectively, are set as new execution torques T1 and T2 (T1=previous T1+Tr1, T2=previous T2+Tr2) (S110), and the present process is terminated. When the execution torques T1 and T2 are set, the switching elements of the first inverter 24 and the second inverter 34 are switched such that the set execution torques T1 and T2 are output from the first motor 22 and the second motor 32.

When the torque rate setting process in FIG. 3 is executed, the electronic control unit 60 first acquires the execution torques T1 and T2 and the target torques T1* and T2* of the first motor 22 and the second motor 32 (S200). Then, determination is made as to whether the target torques T1* and T2* of the first motor 22 and the second motor 32 cross a play region in the drive force transmission system with respect to the execution torques T1 and T2 (S210). Since the play region is basically a region in which the torque crosses a value of 0, the determination as to whether the target torques cross the play region is a determination as to whether or not the target torques T1* and T2* cross a value of 0 with respect to the execution torques T1 and T2.

When determination is made in S210 that the target torques T1* and T2* do not cross the play region with respect to the execution torques T1 and T2, the time needed for the execution torques T1 and T2 to reach the target torques T1* and T2* is divided by the repetition cycle of the execution torque setting process to calculate a variable k (S240). The torque rates Tr1 and Tr2 (Tr1=(T1*−T1)/k, Tr2=(T2*−T2)/k) are calculated by dividing differences between the target torques T1* and T2* and the execution torques T1 and T2 by the variable k (S250). The present process is terminated. The time needed for the execution torques T1 and T2 to reach the target torques T1* and T2* can be obtained according to differences between the target torques T1* and T2* and the execution torques T1 and T2. For example, the target torques T1 and T2 to be executed can be obtained by dividing the larger one of the differences between the standard torques T1* and T2* and the execution torques T1 and T2 by an average value or a median value as a predetermined value or a torque rate.

When determination is made in S210 that the target torques T1* and T2* cross the play region with respect to the execution torques T1 and T2, values near the play region, for example, values slightly exceeding the play region by a predetermined value with respect to the execution torques T1 and T2, or the like are set as the intermediate torques Tm1 and Tm2 (S220). The set intermediate torques Tm1 and Tm2 are set as the target torques T1* and T2* (S230). Then, the time needed for the execution torques T1 and T2 to reach the target torques T1* and T2* is divided by the repetition cycle of the execution torque setting process to calculate a variable k (S240). The torque rates Tr1 and Tr2 are calculated by dividing the differences between the target torques T1* and T2* and the execution torques T1 and T2 by the variable k (S250). The present process is terminated. In this way, the intermediate torques Tm1 and Tm2 are set as values near the play region, and the set intermediate torques Tm1 and Tm2 are processed as the target torques T1* and T2*. As a result, the execution torques T1 and T2 of the first motor 22 and the second motor 32 reach the intermediate torques Tm1 and Tm2 at the same time. Therefore, the execution torques T1 and T2 of the first motor 22 and the second motor 32 cross the play region at the same time.

FIG. 4 is an explanatory diagram showing an example in which target torques T1* and T2* of a first motor 22 and a second motor 32 cross a play region with respect to execution torques T1 and T2. As shown in the drawing, the target torques T1* and T2* of the first motor 22 and the second motor 32 have positive values. The execution torques T1 and T2 have negative values. Therefore, the target torques T1* and T2* cross the play region in which the torque has a value of 0 with respect to the execution torques T1 and T2. In the embodiment, values of torques slightly greater than a value of 0 are set as intermediate torques Tm1 and Tm2. The execution torques T1 and T2 are set to reach the intermediate torques Tm1 and Tm2 at the same time. Therefore, the execution torques T1 and T2 of the first motor 22 and the second motor 32 cross the play region at the same time. Therefore, the driver or the passenger does not feel a shock or the like caused by a deviation in timing at which the execution torques T1 and T2 of the first motor 22 and the second motor 32 cross the play region. On the other hand, when the execution torques T1 and T2 reach the target torques T1* and T2* at the same time without setting the intermediate torques Tm1 and Tm2, there is a case where the timings at which the execution torques T1 and T2 of the first motor 22 and the second motor 32 cross the play region deviate. This gives a driver or a passenger a sense of discomfort, such as a shock.

In the electrified vehicle 20 of the embodiment described above, when the target torques T1* and T2* of the first motor 22 and the second motor 32 cross the play region with respect to the execution torques T1 and T2, values near the play region or values exceeding the play region by a predetermined value are set as the intermediate torques Tm1 and Tm2. The set intermediate torques Tm1 and Tm2 are set as the target torques T1* and T2*. Next, a variable k is calculated based on the time needed for the execution torques T1 and T2 to reach the target torques T1* and T2*, and the torque rates Tr1 and Tr2 are calculated by dividing the differences between the target torques T1* and T2* and the execution torques T1 and T2 by the variable k. Then, the execution torques T1 and T2 are set by a rate limit process using the torque rates Tr1 and Tr2. The switching elements of the first inverter 24 and the second inverter 34 are switched such that the set execution torques T1 and T2 are output from the first motor 22 and the second motor 32. As a result, the execution torques T1 and T2 of the first motor 22 and the second motor 32 cross the play region at the same time. The driver or the passenger does not feel a shock or the like caused by a deviation in timing at which the execution torques T1 and T2 of the first motor 22 and the second motor 32 cross the play region.

The correspondence between the main elements of the embodiment and the main elements of the disclosure described in the column of the means for solving the problems will be described. In the embodiment, the first motor 22 corresponds to the “first electric motor”, the second motor 32 corresponds to the “second electric motor”, and the electronic control unit 60 corresponds to the “control device”.

The correspondence between the main elements of the embodiment and the main elements of the disclosure described in the column of means for solving the problem is an example for specifically describing the embodiment for implementing the disclosure described in the column of means for solving the problem. This is not intended to limit the elements of the disclosure described in the column of the means for solving the problem. That is, the interpretation of the disclosure described in the column of the means for solving the problem should be made based on the description in the column, and the embodiment is merely a specific example of the disclosure described in the column of the means for solving the problem.

Although the present disclosure has been described using the embodiment, the above-described disclosure is not limited to the embodiment, and can be implemented in various forms within the scope of the spirit of the above-described disclosure.

The present disclosure can be used in the manufacturing industries of electrified vehicles.

What is claimed is:

1. An electrified vehicle comprising:
a first electric motor configured to input and output a drive force to and from a first axle;
a second electric motor configured to input and output a drive force to and from a second axle different from the first axle; and
a control device configured to control the first electric motor and the second electric motor,
wherein when target torques of the first electric motor and the second electric motor exceed a play region in which a play occurs with respect to current execution torques, the control device is configured to set intermediate torques near the play region as the target torques, and adjust execution torques of the first electric motor and the second electric motor to reach the target torques at the same time.

2. The electrified vehicle according to claim 1, wherein the intermediate torques are torques that slightly exceed the play region with respect to the current execution torques of the first electric motor and the second electric motor.

3. The electrified vehicle according to claim 1, wherein the control device is configured to
calculate rate values such that the execution torques of the first electric motor and the second electric motor become the intermediate torques at the same time, and
set the execution torques by a rate limit process using the rate values.
